(19) United States
(12) Patent Application Publication
(10) Pub. No.: US 2014/0253306 A1
(43) Pub. Date: Sep. 11, 2014

(54) Electric Vehicle State of Charge Indicator Integrated With Exterior Lamps

(71) Applicant: FORD GLOBAL TECHNOLOGIES. LLC, DEARBORN, MI (US)

(72) Inventor: Brian J. Gillespey, Brownstown, MI (US)

(73) Assignee: FORD GLOBAL TECHNOLOGIES, LLC, DEARBORN, MI (US)

(21) Appl. No.: 13/786,507

(22) Filed: Mar. 6, 2013

(51) Int. Cl. B60Q 1/00

(52) U.S. Cl. CPC B60Q 1/00
USPC 340/425.5

(57) ABSTRACT

An electric vehicle has front, rear, and left and right sides defining four corners and an electric propulsion system including a battery, a charger, and a state of charge monitor determining a battery state of charge. A plurality of exterior lamp assemblies are each disposed at a respective one of the corners. Each lamp assembly is comprised of a sequential chain of LEDs disposed across a respective dimension of the respective lamp assembly. The LEDs of the chain have a placement and separation configured to make the LEDs resolvable at a predetermined distance from the vehicle. The LEDs are configured to be illuminated in a driving mode and a charging mode, wherein the charging mode is comprised of illuminating a portion of the sequential chain of LEDs in proportion to the monitored state of charge of the battery.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to rechargeable electric transportation vehicles, and, more specifically, to a visual indicator of the charge state of a battery during recharging.

Electrically-powered vehicles for roadway use are becoming popular because of reduced energy costs and reduced emissions of pollutants. A full electric or battery electric vehicle (BEV) can be plugged into the high-voltage electric power grid for charging the batteries which then supply all the power for driving the vehicle. A hybrid electric vehicle (HEV) combines the battery and electric drivetrain of a BEV with an internal combustion engine. The gasoline-powered engine may be used to recharge the battery or to provide motive power to the drivetrain, depending on the type of HEV. In a plug-in hybrid (PHEV), the batteries may also be recharged by connecting to the electric grid.

Recharging may typically occur at a power outlet in the car owner's garage or at another recharge location having an appropriate power supply. Since recharging normally requires a significant amount of time, the user leaves the vehicle unattended during most of the recharging process. During charging, it is desirable to display the battery state of charge in order to communicate the recharging progress to the user. This allows the user to anticipate when charging will be complete or to estimate the travel range that has thus far been restored to the battery.

Conventional electrical vehicles typically have used an added indicator placed on or in the vehicle to display the state of charge. Besides the cost of the added components, prior art displays have also required the user to approach or enter the vehicle and to move into the proper position in order to read it.

### SUMMARY OF THE INVENTION

In one aspect of the invention, an electric vehicle has front, rear, and left and right sides defining four corners and an electric propulsion system including a battery, a charger, and a state of charge monitor determining a battery state of charge. A plurality of exterior lamp assemblies are each disposed at a respective one of the corners. Each lamp assembly is comprised of a sequential chain of LEDs disposed across a respective dimension of the respective lamp assembly. The LEDs of the chain have a placement and separation configured to make the LEDs resolvable at a predetermined distance from the vehicle. The LEDs are configured to be illuminated in a driving mode and a charging mode, wherein the charging mode is comprised of illuminating a portion of the sequential chain of LEDs in proportion to the monitored state of charge of the battery.

### BRIEF DESCRIPTION OF THE DRAWINGS

FIG. 1 is a front view of a vehicle with state of charge indicators incorporated with front headlamp assemblies.

FIG. 2 is a left, rear perspective view of the vehicle of FIG. 1 showing state of charge indicators incorporated with a rear tail lamp assembly.

FIGS. 3-5 are front views of a front headlamp assembly with different portions of a sequential chain of LEDs being illuminated to show respect states of charge of the battery.

FIG. 6 is a front view of a tail lamp assembly in greater detail

FIG. 7 is a block diagram showing one preferred embodiment of an electric vehicle of the invention.

### DETAILED DESCRIPTION OF PREFERRED EMBODIMENTS

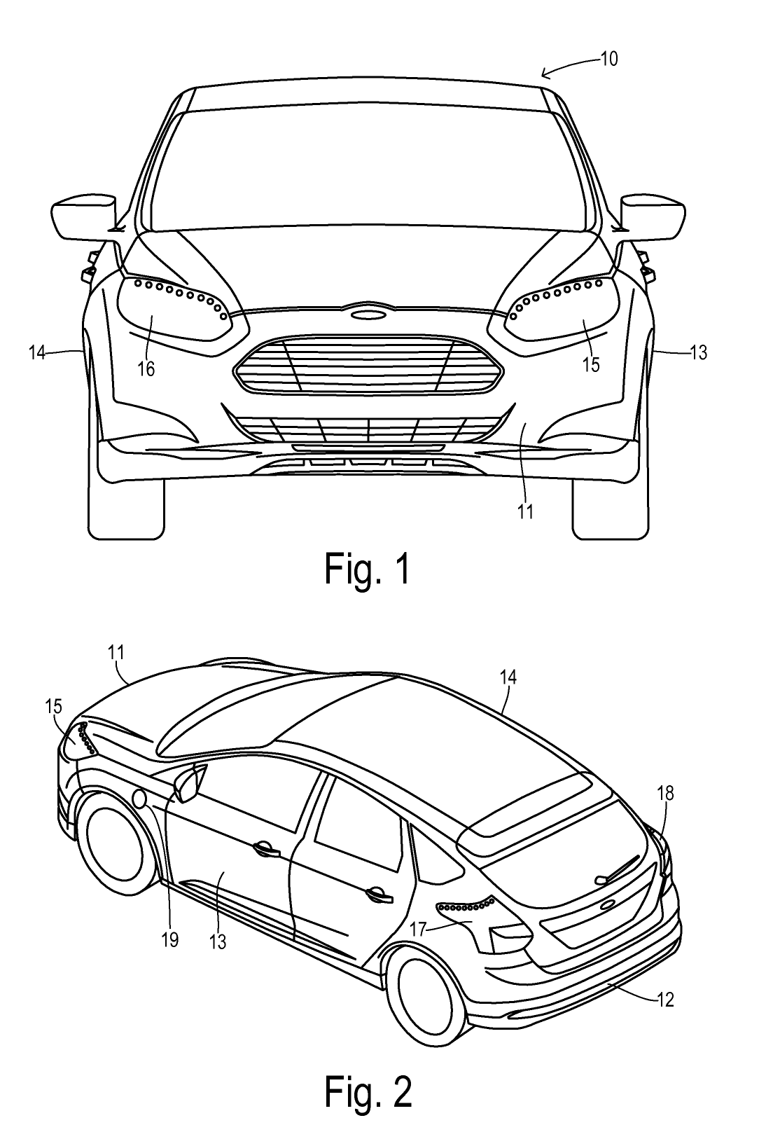

Referring now to FIGS. 1 and 2, an electric vehicle 10 has a front end 11, rear end 12, left side 13 and right side 14 defining four corners of the vehicle which receive respective lamp assemblies 15, 16, 17, and 18. Assemblies 15 and 16 are headlamp assemblies that may combine the functions of headlamps, turn signals, running lights, or other marking functions to illuminate the roadway and generate visible signals for other drivers. Assemblies 17 and 18 are tail lamp assemblies for combining brake light, backup light, turn signals, and other functions. Thus, assemblies 15-18 are well placed around the perimeter of the vehicle so that one or more of the assemblies are always readily visible from any angle surrounding vehicle 10. Electric vehicle 10 includes a power connector socket 19 for interconnecting to a high-voltage power outlet during recharging of the vehicles battery.

A typical exterior lamp assembly includes elements for generating, collecting, and distributing light as known in the art. Optical elements can include reflectors, light guides, and lenses such as a Fresnel lens. A common light source is an array of light emitting diodes (LEDs), especially for brake signaling, running light, and side or corner marking purposes. To reduce the overall cost of components, the present invention employs dual-purpose LEDs in the lamp assemblies that operate in 1) a driving mode to perform a traditional exterior lighting function (e.g. running lights), and 2) a charging mode to display a state of charge of the battery that is visible from a predetermined distance from the vehicle and from any direction to the vehicle.

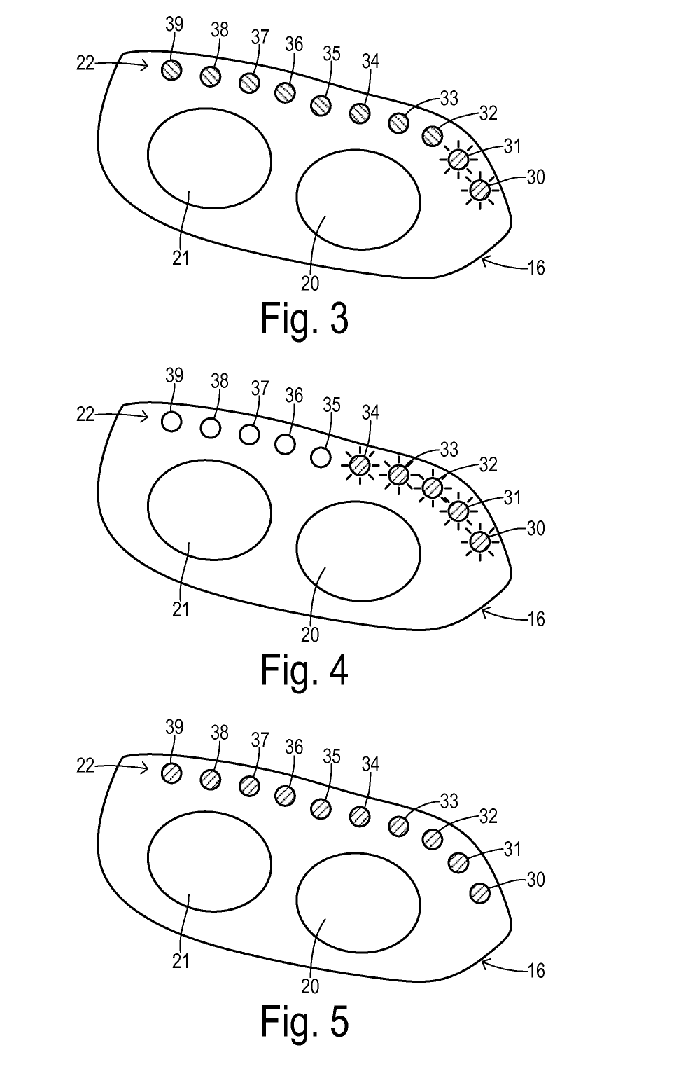

FIG. 3 shows lamp assembly 16 in greater detail having low and high beam headlamps 20 and 21. Disposed across a respective dimension of lamp assembly 16 is a sequential chain of LEDs 22. A dimension over which chain 22 is laid out can be in any generally lineal direction such as vertical, horizontal, or any intermediate orientation or having a curving profile. A lineal nature of chain 22 provides an intuitive sequential order between an initial LED 30 and a final LED 39, with LEDs 31-38 being in sequential order between them. When in the charging mode, LED chain 22 has an activated portion proportional to the battery state of charge. Preferably, each LED represents a predetermined percentage of the battery state of charge. Thus, the illuminated portion of LED chain 22 includes initial LED 30 together with a number of adjacent LEDs in the sequential order that corresponds to the monitored battery state of charge as a percentage of full charge. With a chain having ten LEDs, each LED represents a 10% increment in the battery state of charge. FIG. 3 represents LEDs 30 and 31 as being illuminated, and LEDs 32-39 being either not illuminated, illuminated at a lower level of brightness, or illuminated at a different color so that LEDs 30 and 31 have a distinct appearance from LEDs 32-39 in order to represent a 20% charge on the battery. FIG. 4 represents a 50% battery state of charge with initial LED 30 and adjacent LEDs 31-34 activated while LEDs 35-39 are not activated or are illuminated with a distinguishing visual characteristic (e.g., brightness or color). FIG. 5 represents a 100% battery charge with all LEDs 30-39 in chain 22 being fully activated with a matching visual appearance.

The individual LEDs in each sequential chain have a placement, separation, and individual brightness or intensity to make them resolvable at a predetermined distance from the vehicle, such as 100 feet or more. Besides a steady illumination, activation as used herein may also include a flashing/blinking of the LEDs representing the proportion of the battery already charged or the percentage remaining to be charged. The LEDs can also be used to indicate other aspects of the charging status including errors or faults in either the supplied voltage from the outlet or any of the system components. For example, if the vehicle detects a physical (“plugged-in”) connection with the grid outlet but receives no AC power, then the LEDs could be rapidly flashed to indicate the power failure. Thus, various combinations of flashing or sequencing are used to display both fault and non-fault conditions of a charge event.

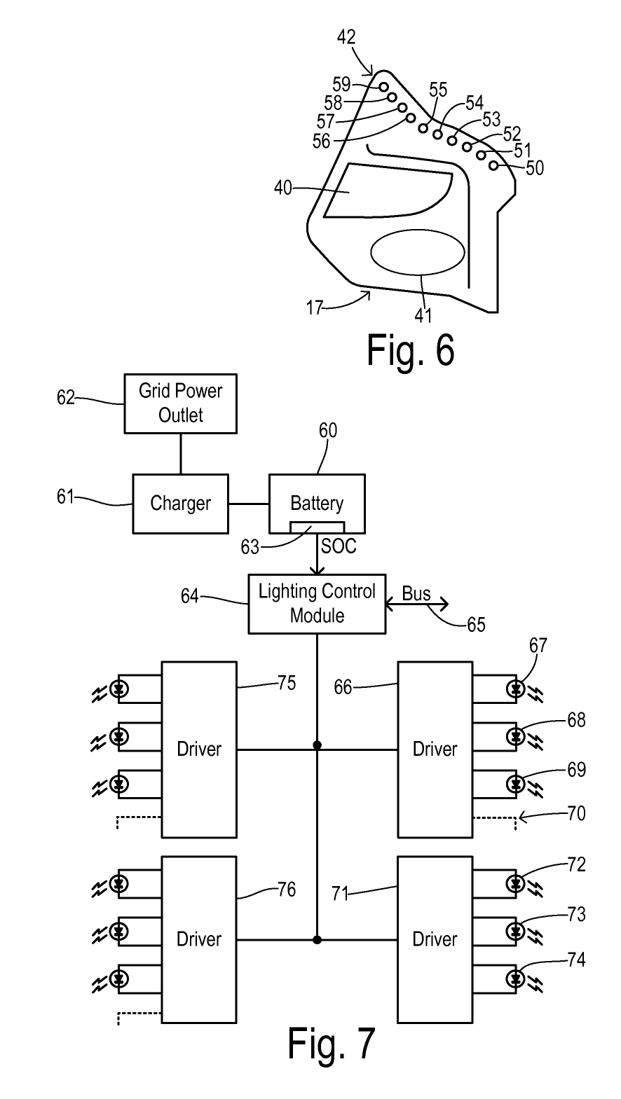

FIG. 6 shows a tail lamp assembly 17 in greater detail including a backup lamp 40, brake lamp 41, and a sequential chain of LEDs 42. Individual LEDs 50-59 are arranged in a sequential order generally following any selected dimension of lamp assembly 17, and preferably following an outer edge of assembly 17. The lamp assembly may also include a two dimensional matrix of LEDs (not shown) which may all be activated during the driving mode but a subset of which are provide the sequential chain for indicating battery charge in the charging mode. Each individual LED shown in the chains herein may alternatively be comprised of a respective group or cluster of adjacent LEDs if desired.

FIG. 7 is a block diagram of an electric vehicle system according to one embodiment of the invention wherein a rechargeable battery 60 is coupled to a charger 61. A grid power outlet 62 is coupled to charger 61 during a charging mode. Battery 60 includes an integrated control 63 that monitors the battery state of charge and interacts with the charger 61 in a conventional manner. The monitored battery state of charge is communicated to a lighting control module 64.

Lighting control module 64 controls activation of various lighting elements such as interior and exterior lamp assemblies as known in the art. A multiplex bus 65 may be provided to link lighting control module 64 to the controlled lighting elements. Signals from battery controller 63 including the battery state of charge signal are used by lighting control module 64 to determine whether it is in a driving mode or a charging mode.

Lighting control module 64 is connected to a driver 66 corresponding to one of the exterior lamp assemblies containing a plurality of LEDs 67-70 of a sequential chain of LEDs serving a dual purpose of providing substantially uniform illumination to mark a respective corner (e.g., braking or marker lights) in a driving mode and indicating a battery state of charge in a charging mode. LED drivers 71, 75, and 76 selectably provide driving signals to respective LEDs (e.g., LEDs 72-74) in sequential chains located in the exterior lamp assemblies at other corners of the vehicle. Drivers 66, 71, 75, and 76 may preferably be located within the respective exterior lamp assemblies. The drivers may be connected to lighting control module 64 via dedicated connections or via a serial bus to receive control signals identifying the battery state of charge and/or the proportion of LEDs in the sequential chain which should be illuminated according to the monitored battery state of charge during the charging mode.

In operation, the electric vehicle system enters a charging mode upon being connected to the grid power outlet. During charging, a battery state of charge is determined by the battery monitoring controller which may preferably be converted to one of a plurality of predetermined percentage levels of charge, such as in 10% increments. In response to the battery state of charge, a portion of each of the sequential chain of LEDs in the exterior lamp assemblies is illuminated in proportion to the monitored battery state of charge. Since the LEDs and the sequential chain have a placement and separation configured to make them resolvable at a predetermined distance from the vehicle, a user can remotely determine the battery state of charge without approaching the vehicle, entering the vehicle, or performing any special actions to access the display.

When the vehicle is not connected with the grid power outlet, the lighting system enters a driving mode in which the sequential chain of LEDs is activated to provide substantially uniform illumination to mark a respective corner for drivers of other vehicles. In other words, the LEDs serve the dual purpose of acting as part of a brake light, running light, or marker light.

What is claimed is:

1. An electric vehicle having front, rear, and left and right sides defining four corners, comprising:
an electric propulsion system including a battery, a charger, and a state of charge monitor determining a battery state of charge; and
a plurality of exterior lamp assemblies each disposed at a respective one of the corners;
wherein each lamp assembly is comprised of:
a sequential chain of LEDs disposed across a respective dimension of the respective lamp assembly, wherein the LEDs of the chain have a placement and separation configured to make the LEDs resolvable at a predetermined distance from the vehicle, wherein the LEDs are configured to be illuminated in a driving mode and a charging mode, wherein the charging mode is comprised of illuminating a portion of the sequential chain of LEDs in proportion to the monitored state of charge of the battery.

2. The vehicle of claim 1 wherein each sequential chain of LEDs has a sequential order between an initial LED and a final LED, wherein each LED represents a predetermined percentage of the battery state of charge, and wherein the illuminated portion of the chain of LEDs includes the initial LED with a number of adjacent LEDs in the sequential order corresponding to the monitored battery state of charge as a percentage of full charge.

3. The vehicle of claim 2 wherein each sequential chain of LEDs is comprised of ten LEDs, each LED representing a 10% increment in the battery state of charge.

4. The vehicle of claim 1 further comprising:
a lighting control module for coordinating operation of the plurality of exterior lamp assemblies during driving of the vehicle, wherein the lighting control module activates the driving mode of a sequential chain of LEDs to provide substantially uniform illumination to mark a respective corner for drivers of other vehicles.

5. The vehicle of claim 4 wherein each lamp assembly further comprises an LED driver coupled to the lighting control module, the state of charge monitor, and the respective chain of LEDs, wherein the LED driver activates selected LEDs in the chain of LEDs according to the battery state of charge when in the charging mode and uniformly activates all the LEDs in the chain of LEDs under control of the lighting control module when in the driving mode.

6. The vehicle of claim 1 wherein the charging mode is further comprised of flashing one of more LEDs in response to a fault condition associated with charging of the battery.

7. A method of operating an electric vehicle having front, rear, and left and right sides defining four corners, and having an electric propulsion system including a battery and a charger, the method comprising the steps of:
entering a charge mode of the vehicle;
determining a battery state of charge;
illuminating a sequential chain of LEDs in each of a plurality of exterior lamp assemblies each disposed at a respective one of the corners, wherein each sequential chain of LEDs is disposed across a respective dimension of the respective lamp assembly, wherein the LEDs of the chain have a placement and separation configured to make the LEDs resolvable at a predetermined distance from the vehicle, and wherein a portion of the sequential chain of LEDS is illuminated in proportion to the monitored state of charge of the battery;
entering a driving mode of the vehicle; and
activating at least one sequential chain of LEDs to provide substantially uniform illumination to mark a respective corner for drivers of other vehicles.

8. The method of claim 7 wherein each sequential chain of LEDs has a sequential order between an initial LED and a final LED, wherein each LED represents a predetermined percentage of the battery state of charge, and wherein the illuminated portion of the chain of LEDs includes the initial LED with a number of adjacent LEDs in the sequential order corresponding to the monitored battery state of charge as a percentage of full charge.

9. The method of claim 8 wherein each sequential chain of LEDs is comprised of ten LEDs, each LED representing a 10% increment in the battery state of charge.

10. The method of claim 7 further comprising the step of:
flashing one of more LEDs in response to a fault condition associated with charging of the battery when in the charge mode.

11. An electric vehicle comprising:
a plurality of exterior lamp assemblies visible from respective directions at a distance from the vehicle;
wherein each lamp assembly comprises a sequential chain of LEDs configured to be activated in a driving mode having uniform illumination or a charging mode comprised of activating a portion of the sequential chain of LEDS in proportion to a monitored state of charge of the battery.
